(19) United States
(12) Patent Application Publication
(10) Pub. No.: US 2024/0225061 A1
(43) Pub. Date: Jul. 11, 2024

(54) Shelf Stable Food with Flavor

(71) Applicant: General Mills, Inc., Minneapolis, MN (US)

(72) Inventors: Linghua A. Han, Plymouth, MN (US); Jeffrey T. Huber, Robbinsdale, MN (US); Diana Lee Kittleson, Andover, MN (US); Elizabeth Lomauro Igo, Maple Grove, MN (US); Morgan Redemann, Minneapolis, MN (US); Carly Sippel, Minneapolis, MN (US)

(73) Assignee: General Mills, Inc., Minneapolis, MN (US)

(21) Appl. No.: 18/285,757

(22) PCT Filed: Apr. 19, 2021
(86) PCT No.: PCT/US2021/027886

§ 371 Date: Oct. 5, 2023

(51) Int. Cl. A23L 19/00; A23L 27/00; A23P 10/20

(52) U.S. Cl. CPC A23L 19/05; A23L 27/72; A23P 10/20

(57) ABSTRACT

Methods are disclosed for making a shelf stable food containing a flavorant having improved intensity over shelf life. Methods include applying a powdered flavorant to a surface of dried fruit pieces prior to combining the dried fruit pieces with a binder to form an aggregate. Shelf stable foods made according to the disclosed methods are also disclosed.

### BACKGROUND

Consumers are increasingly looking for convenient foods that are enjoyable to eat. Foods made from aggregates of grains, nuts, and/or dried fruits, such as granola bars and nut clusters, are examples of shelf stable, convenient foods that consumers enjoy.

### SUMMARY

The present disclosure relates to methods of applying a flavor to improve intensity and/or shelf stability.

Provided herein is a method of making a shelf stable food. The method includes applying a powdered flavorant to a surface of dried fruit pieces to produce powder coated fruit pieces, where the powder coated fruit pieces include the powdered flavorant in an amount of 0.1% to 20% by weight of the dried fruit pieces; combining the powder coated fruit pieces with a fluid binder to form an aggregate; and setting a structure of the fluid binder in the aggregate to form the shelf stable food including particulates and a set binder, the particulates including the dried fruit pieces having the powdered flavorant localized to the surface of the dried fruit pieces.

In some embodiments, a powdered flavorant can include an encapsulated flavorant.

In some embodiments, the step of applying the powdered flavorant to the surface of dried fruit pieces can be performed during a delumping process.

In some embodiments, the fluid binder can be at a temperature of greater than 130° F. and/or less than 200° F. during the step of combining the powdered coated fruit pieces with the fluid binder.

In some embodiments, the step of setting the structure of the fluid binder can include heating the aggregate to a temperature greater than 180° F. and/or up to 250° F.

In some embodiments, the fluid binder can include an acidulent. In some embodiments, the acidulent can include citric acid. In some embodiments, the acidulant can include a fruit juice in an amount of 0.2% to 1% by weight of the fluid binder.

In some embodiments of a method of making a shelf stable food provided herein, the method can include a step of forming the aggregate into portions.

In some embodiments of a method of making a shelf stable food provided herein, the shelf stable food can be a crunchy snack food.

A shelf stable food is provided herein. The food includes particulates bound by a set binder, where the particulates include dried fruit pieces having a powdered flavorant localized to a surface of the dried fruit pieces, where the powdered flavorant is included in an amount of from 0.1% to 20% by weight of the dried fruit pieces.

In some embodiments, a powdered flavorant can include an encapsulated flavorant.

In some embodiments, the fluid binder can include an acidulent. In some embodiments, the acidulent can include citric acid. In some embodiments, the acidulant can include a fruit juice.

In some embodiments, a shelf stable food can be a crunchy snack food. In some embodiments, a shelf stable food can be a snack bar.

In some embodiments of a shelf stable food provided herein, the dried fruit can comprise a first dried fruit having a first powdered flavorant localized to the surface of the first dried fruit and a second dried fruit having a second powdered flavorant localized to the surface of the second dried fruit.

These and various other features and advantages will be apparent from a reading of the following detailed description.

### DETAILED DESCRIPTION

Many flavorants, especially natural flavorants, are sensitive to heat and can lose flavor intensity when exposed to high temperatures during or after manufacturing. Even if such flavorants are not degraded from heat during or after manufacture, they often lose flavor intensity over the shelf life of shelf stable foods. While powdered flavorants can be more stable than liquid flavorants, they are also prone to loss in flavor intensity over time. Flavorant manufacturers have developed flavorants that are less susceptible to flavor loss following exposure to heat and over shelf life using methods, such as encapsulation. However, it was discovered by the present inventors that even encapsulated, powdered flavorants can lose flavor intensity over shelf life in aggregate foods that include a binder that binds particulates together.

It was surprisingly discovered, and is disclosed herein that powdered flavorants, even those marketed as being encapsulated or having an improved shelf life, can have a more intense flavor profile over shelf life if they are applied to a surface of a dried fruit piece prior to being enrobed with a binder to produce a shelf stable food.

Another benefit of applying a powdered flavorant to a surface of a dried fruit piece prior to being combined with a binder is that the powdered flavorant tends to remain localized to the surface of the dried fruit piece over shelf life, creating a more intense authentic flavor that is localized to the dried fruit piece. This provides a “what you see is what you taste” type of eating experience that is different from the more diffuse flavor obtained when flavorant is dispersed in a binder.

In addition, such a method can benefit from using the application of a powdered flavorant to dried fruit pieces as a delumping step to prevent dried fruit pieces from forming large agglomerates of fruit pieces in the finished product.

A method for making a shelf stable food provided herein includes a step of applying a powdered flavorant to a surface of dried fruit pieces to produce powder coated fruit pieces. A powdered flavorant can be applied at a rate of from about 0.1% to about 20% (e.g., about 0.5% to about 10%, or about 0.75% to about 5%) by weight of the dried fruit pieces. That is, for every 100 grams of dried fruit used to produce powder coated fruit pieces, from about 0.1 grams to about 20 grams of a powdered flavorant can be used.

As used herein, a powdered flavorant refers to a dry, powdered composition suitable for use as a flavorant in a food. It is to be understood that a powdered flavorant can contain bulking or carrier agents, such as sugars, gums, starches, proteins, or fibers, to improve handling properties. However, a flavorant must also include at least one compound (flavor compound) that can contribute a characterizing flavor note other than saltiness or sweetness to a food that contains the flavorant. Examples include natural flavorants, such as concentrated juices, powdered fruits and vegetables, and extracts from herbs, spices, nuts, fruits, or vegetables; and artificial flavorants. Amounts of powdered flavorants used herein includes the weight of any bulking agents or carrier agents included as part of a powdered flavorant. Thus, an amount of powdered flavorant described herein may include only a portion of the amount as a flavor compound. In some cases, a powdered flavorant can include more than 60% by weight of a carrier, often about 70% to about 98% depending on the intensity of a flavor compound. For example, if a powdered flavorant is included in an amount of 10% by weight of dried fruit pieces to produce powder coated fruit, the powder coated fruit may contain 4% or less of flavor compound by weight of dried fruit pieces.

In some embodiments, a powdered flavorant can include an encapsulated flavorant. An encapsulated flavorant can be produced using any appropriate method, such as spray drying, spray cooling, extrusion, molecular inclusion, and coacervation. The compounds that contribute flavor in an encapsulated flavorant need not be a powder so long as the encapsulated flavorant is in dry, powdered form overall. For example, an encapsulated flavorant can be a powder that includes an encapsulated oil containing flavor compounds.

In some embodiments, a flavorant can be selected to match the type of dried fruit used in a shelf stable food. For example, if dried cherries are used as dried fruit pieces, then a powdered cherry flavorant can be used. In some embodiments, a flavorant need not provide the expected flavor for the dried fruit pieces used. For example, if dried cranberries are used, the flavorant need not be cranberry flavored, but can be a different flavor, such as cherry, blueberry, or strawberry.

In some embodiments, multiple flavorants can be used. For example, in some embodiments, multiple flavorants can be used on a single dried fruit type to provide a complex flavor while containing only one type of dried fruit. For example, a dried blueberry flavorant and a dried lemon flavorant can both be applied to dried blueberries to produce powdered coated fruit pieces that include dried fruit pieces (blueberries) that each have both dried lemon and dried blueberry flavorants on their surfaces.

In some embodiments, multiple flavorants can be used on a mixture of dried fruits. For example, a dried blueberry flavorant and a dried lemon flavorant can both be applied to a mixture of dried blueberries and dried apple pieces to produce powdered coated fruit pieces that include dried fruit pieces (blueberries and apples) that each have both dried lemon and dried blueberry flavorants on their surfaces.

In another example, different flavorants can be applied to different dried fruits such that each flavor is localized to a different type of dried fruit piece. For example, a dried blueberry flavorant can be applied to dried blueberries to produce powdered coated fruit pieces that include dried fruit pieces (blueberries) that each have dried blueberry flavorant on their surface, and a dried cherry flavorant can be applied to dried cranberries and/or dried cherries to produce powder coated fruit pieces that include dried fruit pieces (cranberries and/or cherries) that each have dried cherry flavorant on their surface. In such embodiments, powder coated fruit pieces containing different dried fruits with different flavorants can be combined with each other and/or a fluid binder in any order.

Any edible dried fruit pieces can be used, including without limitation, raisins, cranberries, blueberries, cherries, mangoes, apples, strawberries, pomegranates, and the like. In some embodiments, it is preferred that dried fruit pieces have a moisture content of about 10% to about 20% or a water activity (Aw) of about 0.4 to about 0.7. In some embodiments, dried fruit pieces can have a soft, spongy, and/or chewy texture. In some embodiments, dried fruit pieces can be glycerol-infused, sugar solution- or sugar syrup-infused, or oil-infused. In some embodiments, dried fruit pieces can have a wrinkled surface that can increase flavorant interaction with the surface of the dried fruit pieces. In some embodiments, dried fruit pieces can include freeze-dried fruit pieces.

In some embodiments, the step of producing powder coated fruit pieces can act to delump the fruit pieces used. It was surprisingly found that a powdered flavorant can be used to delump fruit pieces without requiring the addition of other delumping agents, such as starch or sugar. In such embodiments, the amount of powdered flavorant used can be selected to achieve the desired delumping without the addition of other delumping agents. For example, an amount of powdered flavorant used to delump fruit pieces can be from about 1% to about 10% by weight of dried fruit pieces.

A powdered flavorant and dried fruit pieces can be combined using any appropriate method and equipment to produce powder coated fruit pieces. In some embodiments, a powdered flavorant and dried fruit pieces can be mixed (e.g., stirred, tumbled, or otherwise mixed) for up to 5 minutes (e.g., about 30 seconds to about 4 minutes, or about 1 minute to about 3 minutes). In some embodiments, other particulates can be included during part or all of the time used to mix a powdered flavorant and dried fruit pieces to produce powder coated fruit pieces.

In some embodiments, powder coated fruit pieces can be combined with other particulates prior to combining the powder coated fruit pieces with a fluid binder. In some embodiments, other particulates can be added after combining powder coated fruit pieces with a fluid binder. Other suitable particulates include, without limitation, nuts or nut pieces (e.g., almond, peanut, pistachio, cashew, and the like), seeds or seed pieces (e.g., sunflower, pumpkin, quinoa, chia, flax, and the like), rolled, cut, or puffed grains (e.g., oats, wheat, barley, rice, and the like), protein crisps, puffs, or bits (e.g., soy, pea milk, whey, and the like), confectionary pieces (e.g., chocolate, candy, marshmallows, and the like), and the like, or any combination thereof.

Powder coated fruit pieces are combined with a fluid binder to form an aggregate that includes the powder coated fruit pieces, the fluid binder, and any other optional ingredients, such as particulates or acidulents. A fluid binder can be any fluid that, upon setting, binds particulates together to form a shelf stable food. Any binder suitable for producing a shelf stable food can be used, such as carbohydrate-based binders (e.g., sugar-based, starch-based, polydextrose-based, soluble fiber-based, and the like), protein-based binders, and fat-based binders (e.g., nut butter-based, compound coating-based).

A fluid binder can be formulated to achieve the desired binding properties in the set binder and texture of the final shelf stable food. A fluid binder can be set to produce a flexible binder to produce a chewy shelf stable food with improved flavorant intensity over shelf life. However, the method provided herein is particularly effective at maintaining flavorant intensity over shelf life if the fluid binder sets to produce a rigid binder to produce a crunchy or crispy shelf stable food.

It was surprisingly found that a significant amount of powdered flavorant in powder coated fruit pieces remained localized to a surface of a fruit piece (e.g., within 100 μm, within 50 μm, or within 10 μm) even after being combined with a fluid binder, and in the final shelf stable food. In some embodiments, a fluid binder having a viscosity of about 5,000 cP to about 25,000 cP (e.g., about 8,000 cP to about 18,000 cP) to further limit mobility of a powdered flavorant. As used herein, viscosity of a fluid binder can be measured at a constant temperature of 50° C. using a Brookfield Rotational Viscometer DV-II+Pro (Brookfield Engineering, Middleboro, Massachusetts, USA) fitted with an SC4-27 spindle, a spindle speed of 35 rpm, and a torque of 10-100. In some embodiments, a fluid binder having a moisture content of about 15% to about 25% (e.g., about 18% to about 22%) can be selected to reduce dissolution of a powdered flavorant.

The amount of binder in an aggregate can be adjusted based on the desired nutritional content, texture, and/or appearance of the final shelf stable food. In some embodiments, a binder can be included in an amount of from about 10% to about 50% (e.g., about 15% to about 25%, or about 20%) by weight of an aggregate.

In some embodiments, a fluid binder can include an acidulent, such as an organic acid (e.g., citric acid, malic acid, ascorbic acid, tartaric acid, and the like), in an amount sufficient to increase the intensity of a flavorant. For example, an acidulent can be included in a fluid binder in an amount of about 0.2% to about 1% (e.g., about 0.5% to about 0.9%, or about 0.75%) by weight of the fluid binder. An acidulent can be added to a fluid binder alone, or as part of a fruit juice (e.g., lemon juice, lime juice, and the like) or other food ingredient.

In some embodiments, a fluid binder can be at a temperature of greater than 130° F. (e.g., at least 140° F., at least 150° F., or from about 140° F. to about 180° F.). Surprisingly, when a method provided herein is used, a fluid binder at temperatures greater than 130° F. can be used with little impact on the intensity of the flavorant.

In some embodiments, an aggregate can be at a temperature of less than 100° F. (e.g., about 70° F. to about 95° F., or about 85° F. to about 90° F.) following combining a fluid binder with powder coated fruit pieces.

A method of making a shelf stable food includes setting a structure of a fluid binder in an aggregate to form a set binder that binds particulates together in the shelf stable food. Typically, setting a structure of a fluid binder includes reducing the moisture content of the fluid binder to achieve a flexible or rigid structure in the resulting set binder. A shelf stable food in which the set binder is rigid can generally have a crunchy texture, while a shelf stable food in which the set binder is flexible can generally have a chewier texture, although particulates might contribute other textures.

In some embodiments, setting a structure of a fluid binder can include reducing the moisture content of the fluid binder to a moisture content in a set binder of less than 12% (e.g., about 8% to about 10%). It is to be understood that the amounts of ingredients as a percentage of a set binder can change relative to the amounts in the original fluid binder due to water loss. For example, the content of an acidulent may increase in a set binder relative to the amount in the fluid binder. In some embodiments, the moisture content of the final shelf stable food can be less than 12% (e.g., about 8% to about 10%).

In some embodiments, a step of setting a structure of a fluid binder in an aggregate includes heating (e.g., baking) the aggregate at a temperature and time sufficient to set the structure. For example, in some embodiments heating at a temperature of greater than 180° F. can be used to set a structure of a fluid binder. In some embodiments, a step of setting a structure of a fluid binder in an aggregate includes heating the aggregate at a temperature up to 300° F. For example, in some embodiments, a step of setting a structure of a fluid binder in an aggregate can include heating the aggregate at a temperature of about 200° F. to about 250° F. (e.g., about 200° F. to about 220° F.) for about 8 minutes to about 15 minutes (e.g., about 9 minutes to about 12 minutes).

An aggregate provided herein can be formed using any appropriate method (e.g., extruded, cut, pinched, rolled, slabbed, or the like) into any appropriate form (e.g., snack bar, bites, or the like) before or after setting the structure of the fluid binder. For example, an aggregate can be slabbed and heated to set the structure of the fluid binder, and then cut into bars after the fluid binder structure is set. In another embodiment, an aggregate can be molded into pieces prior to setting the structure of the fluid binder, and then the pieces can be heated to set the structure of the fluid binder to produce snack bites.

A shelf stable food can be packaged as desired for storage (e.g., in bulk) or sale (e.g., individually packaged pieces).

The following examples are provided to illustrate embodiments of the invention.

### Examples

Samples of snack bars were made using aggregates that included dried fruit pieces (dried blueberries) and other particulates, a flavorant (dried or liquid), and one of two different carbohydrate-based fluid binders. The aggregates were formed into bars, which were then heated at about 220° F. to 250° F. to set the binder. Following setting of the binder, each bar was individually packaged in a metalized flexible laminated pouch.

The aggregates are described in Table 1.

TABLE 1

| Sample | Flavorant type | Flavorant addition | Binder |
|---|---|---|---|
| 1 | Powdered flavorant | Combined with | A |
| | (encapsulated | dried fruit to form | |
| | blueberry) | powder coated fruit | |
| | | pieces | |
| 2 | Powdered flavorant | Combined with | B |
| | (encapsulated | dried fruit to form | |
| | blueberry) | powder coated fruit | |
| | | pieces | |
| 3 | Powdered flavorant | Combined with | A |
| | (encapsulated | fluid binder | |
| | blueberry) | | |
| 4 | Liquid flavorant | Combined with | A |
| | (blueberry) | fluid binder | |
| 5 | No flavorant | No flavorant added | B |

Each sample had a set of bars that were subjected to accelerated shelf life test conditions, and a set of bars that were held at 0° F. (reference samples). At four- eight- and 12-week intervals of accelerated shelf life testing, each sample was tasted to compare to its reference sample, and scored according to Table 2.

Accelerated shelf life test conditions were at 90° F. and 15% relative humidity, where each 1 week of time under accelerated shelf life test conditions was roughly equivalent to about 3 weeks of shelf life at ambient conditions.

TABLE 2

| Score | Description |
|---|---|
| 1 | Same as the reference sample |
| 2 | Slight changes from the reference sample that are not noticeable |
| | unless compared to the reference |
| 3 | Changes from the reference sample that are noticeable without |
| | comparing to the reference |
| 4 | Noticeable changes that consumers would notice and start |
| | complaining |
| 5 | Complete product failure |

Average scores for each sample are provided in Table 3.

TABLE 3

| | | Flavor score | Flavor score | Flavor score |
|---|---|---|---|---|
| | | 4 wks | 8 wks | 12 wks |
| | Flavorant | accelerated (12 | accelerated (24 | accelerated (36 |
| | type/ | weeks ambient | weeks ambient | weeks ambient |
| Sample | application | equivalent) | equivalent) | equivalent) |
| 1 | Powder | 1.5 | 2 | 2 |
| | coated fruit | | | |
| | pieces | | | |
| 2 | Powder | 2 | 2.5 | 2 |
| | coated fruit | | | |
| | pieces | | | |
| 3 | Powdered | 2.5 | 3.5 | 4 |
| | flavorant | | | |
| | in binder | | | |
| 4 | Liquid | 2 | 3 | 4 |
| | flavorant | | | |
| | in binder | | | |
| 5 | No flavorant | 1.5 | 2.5 | 3 |

As apparent from Table 3, samples that combined a powdered flavorant with dried fruit pieces to produce powder coated fruit pieces prior to combining with a binder had scores of less than 3 over the entire study. In contrast, samples that included a powdered flavorant or a liquid flavorant in the binder had scores of 3 or higher beginning as early as 8 weeks of accelerated shelf life (equivalent to about 24 weeks at ambient conditions). Interestingly, the sample that contained no added flavor also had a score of 3 at 12 weeks of accelerated shelf life (equivalent to about 36 weeks at ambient conditions). It is believed that this is because early changes in flavor from some of the particulates could be detected in the sample with no added flavor, which were masked by flavorant that remained intense in the samples that used powder coated fruit pieces.

Samples made during a pilot plant test run using powder coated fruit pieces were subjected to an accelerated shelf life test with similar results to samples 1 and 2 above.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of making a shelf stable food, the method comprising:
a. applying a powdered flavorant to a surface of dried fruit pieces to produce powder coated fruit pieces, the powder coated fruit pieces including the powdered flavorant in an amount of 0.1% to 20% by weight of the dried fruit pieces;
b. combining the powder coated fruit pieces with a fluid binder to form an aggregate; and
c. setting a structure of the fluid binder in the aggregate to form the shelf stable food including particulates and bound by a set binder, the particulates including the dried fruit pieces having the powdered flavorant localized to the surface of the dried fruit pieces.

2. The method of claim 1, wherein the powdered flavorant comprises an encapsulated flavorant.

3. The method of claim 1, wherein the step of applying the powdered flavorant to the surface of dried fruit pieces is performed during a delumping process.

4. The method of claim 1, wherein the fluid binder is at a temperature of greater than 130° F. during the step of combining the powdered coated fruit pieces with the fluid binder.

5. The method of claim 4, wherein the fluid binder is at a temperature of less than 200° F. during the step of combining the powdered coated fruit pieces with the fluid binder.

6. The method of claim 1, wherein the step of setting the structure of the fluid binder comprises heating the aggregate to a temperature greater than 180° F.

7. The method of claim 6, wherein the step of setting the structure of the fluid binder comprises heating the aggregate to a temperature up to 250° F.

8. The method of claim 1, wherein the fluid binder comprises an acidulent.

9. The method of claim 8, wherein the acidulent comprises citric acid.

10. The method of claim 8, wherein the acidulant comprises a fruit juice in an amount of 0.2% to 1% by weight of the fluid binder.

11. The method of claim 1, comprising a step of forming the aggregate into portions.

12. The method of claim 1, wherein the shelf stable food is a crunchy snack food.

13. A shelf stable food, comprising particulates bound by a set binder, the particulates including dried fruit pieces having a powdered flavorant localized to a surface of the dried fruit pieces, the powdered flavorant included in an amount of from 0.1% to 20% by weight of the dried fruit pieces.

14. The food of claim 13, wherein the powdered flavorant comprises an encapsulated flavorant.

15. The food of claim 13, wherein the binder comprises an acidulent.

16. The food of claim 15, wherein the acidulent comprises citric acid.

17. The food of claim 15, wherein the acidulant comprises a fruit juice.

18. The food of claim 13, wherein the food is a crunchy snack food.

19. The food of claim 13, wherein the food is a snack bar.

20. The food of claim 13, wherein the dried fruit comprises a first dried fruit having a first powdered flavorant localized to the surface of the first dried fruit and a second dried fruit having a second powdered flavorant localized to the surface of the second dried fruit.
